(19) United States
(12) Patent Application Publication
(10) Pub. No.: US 2026/0212128 A1
(43) Pub. Date: Jul. 23, 2026

(54) GENERATIVE AI-BASED AGENTIC ARCHITECTURE FOR PREDICTIVE MAINTENANCE SYSTEMS AND APPLICATIONS

(71) Applicant: NVIDIA Corporation, Santa Clara, CA (US)

(72) Inventors: Sugandha Sharma, Cambridge, MA (US); Hai Huang, Houston, TX (US); Janaki Vamaraju, Austin, TX (US); Avinash Kaur, San Francisco, CA (US); Ze Yang, Santa Clara, CA (US)

(21) Appl. No.: 19/035,620

(22) Filed: Jan. 23, 2025

(51) Int. Cl. G06F 40/30; G06F 16/242; G06F 16/28; G06F 16/3329

(52) U.S. Cl. CPC G06F 40/30; G06F 16/2433; G06F 16/284; G06F 16/3329

(57) ABSTRACT

In various examples, a generative AI-based agentic framework may be used to answer complex queries in predictive maintenance, enabling the use of natural language queries to extract information about machines and systems. For instance, the systems and methods of the present disclosure may route an incoming query to a specific language model based on the complexity of the query, and the specific language model may be used to execute a Reasoning and Acting (ReACT) framework to generate a response to the query. In some examples, the language model may decompose the query into different parts and assign these different parts to different AI-based agents, which may use their own tools, models, algorithms, etc., to address the different parts of the decomposed query. The language model may then form the response to the query using information obtained from the agents.

### BACKGROUND

Predictive maintenance is a proactive approach that may be used to predict equipment failures before the failures occur. By leveraging sensors, machine learning, historical data, and/or other information, predictive maintenance techniques may enable real-time monitoring to detect early signs of issues, allowing manufacturers or other users to take preemptive actions, minimize downtime, and optimize maintenance schedules for their machines or equipment. Among other things, predictive maintenance approaches may help reduce unnecessary maintenance, lower operational costs, and enhance reliability by preventing unexpected failures. By integrating these techniques into their operations, organizations may be able to achieve more efficient resource utilization and extend the lifespan of critical assets.

However, predicting machine failures is often a challenging and/or time-consuming process. For instance, machine history and other relevant data may typically be stored in large databases, and the user interfaces for querying these databases may not be intuitive or user-friendly. Furthermore, users may frequently be required to perform multiple, often disconnected steps to retrieve actionable insights from this data. For example, a user might first need to retrieve the relevant data from one or more relational databases (e.g., SQL databases), then process the data using machine learning models or other analytical tools to extract insights about the machines, and finally use additional tools to visualize the results (e.g., in the form of graphs or plots). This fragmented process may not only demand significant technical expertise but may also increase the likelihood of errors and inefficiencies, creating barriers to effective predictive maintenance implementations.

### SUMMARY

Embodiments of the present disclosure relate to a generative AI-based agentic architecture for predictive maintenance systems and applications. Systems and methods are disclosed that may be used to answer complex queries in predictive maintenance, enabling the use of natural language queries to extract information about machines and systems. For instance, a system(s) may route an incoming query to a specific language model based on the complexity of the query, and the language model may be used to execute a Reasoning and Acting (ReACT) framework to generate a response to the query. In some examples, the language model may decompose the query into different parts and the system(s) may assign these different parts to different AI-based agents, which may use their own tools, models, algorithms, etc., to address the different parts of the decomposed query and return various information. The system(s) may then use the language model to form the response to the query based on the information obtained from the agents. In various instances, the response to the query may indicate a probability of a certain machine or system failing, an estimated date or time until failure, trends in failures (e.g., a component(s) that may likely cause the failure), or any other predictive maintenance-related information.

In contrast to conventional systems, the systems of the present disclosure, in some embodiments, may be able to automate end-to-end predictive maintenance workflows to answer complex queries without human intervention. For instance, by using a generative AI-based agentic architecture, the systems of the present disclosure may allow users to interact with complex databases using natural language queries (e.g., text, speech, etc.). In this way, users having even a basic level of knowledge of the system may be able to easily monitor the system via the generative AI-based agentic architecture. Additionally, in contrast to conventional systems, the systems of the present disclosure may, in some embodiments, be able to decrease inference costs without sacrificing response quality. For instance, by adaptively selecting a specific language model(s) to use to execute a ReACT framework based on the complexity of a query, the systems of the present disclosure may minimize inference costs while maintaining response quality by selecting the best-suited language model for a given query.

### BRIEF DESCRIPTION OF THE DRAWINGS

The present systems and methods for a generative AI-based agentic architecture for predictive maintenance systems and applications are described in detail below with reference to the attached drawing figures, wherein:

FIG. 1 is a data flow diagram illustrating an example of a process for using a generative AI-based agentic architecture for predictive maintenance to generate a response to a query, in accordance with some embodiments of the present disclosure;

FIG. 2 is a block diagram illustrating example detail associated with an agent, in accordance with some embodiments of the present disclosure;

FIG. 3 is a data flow diagram illustrating an example of a process for policy-based selection of a language model, in accordance with some embodiments of the present disclosure;

FIG. 4 illustrates an example of a multi-agent architecture associated with a predictive maintenance system, in accordance with some embodiments of the present disclosure;

FIG. 5 illustrates an example workflow associated with a reasoning and decision-making framework that may be executed, at least in part, using a language model, in accordance with some embodiments of the present disclosure;

FIG. 6 is a data flow diagram illustrating example data communications that may take place during execution of the reasoning and decision making framework of FIG. 5, in accordance with some embodiments of the present disclosure;

FIG. 7 is a block diagram illustrating an example of a system that may perform one or more of the processes described herein, in accordance with some embodiments of the present disclosure;

FIG. 8 is a flow diagram illustrating an example of a method that may be implemented by a generative AI-based agentic architecture for predictive maintenance, in accordance with some embodiments of the present disclosure;

FIG. 9 is a flow diagram illustrating an example of a method for responding to a query using an agentic architecture for predictive maintenance, in accordance with some embodiments of the present disclosure;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Systems and methods are disclosed related to a generative AI-based agentic architecture for predictive maintenance systems and applications. For instance, the agentic architecture may be used to answer complex queries in predictive maintenance, enabling the use of natural language queries to extract information about machines, equipment, and/or any other kinds of systems. By way of example, and not limitation, a system(s) may analyze an input query to select one or more language models (e.g., an optimal or preferred language model - such as a large language model (LLM), vision language model (VLM), multi-modal language model (MMLM), etc.) based on the complexity of the query, and the language model(s) may be used by the system(s) to execute a Reasoning and Acting (ReACT) framework and generate a response to the query. In some examples, the system(s) may use the language model(s) to decompose the query into different parts (also referred to as “sub-queries”) and assign these different parts to different artificial intelligence-based (AI-based) agents (e.g., LLM/VLM/MMLM/etc. agents). The agents may use their own specialized tools, models, algorithms, etc., to address the different parts of the decomposed query and return various information. The system(s) may then use the language model(s) to form the response to the query based on the information obtained from the agents. In various instances, the response to the query may indicate a probability of a certain machine or system failing, an estimated date or time until failure, trends in failures (e.g., a component(s) that may likely cause the failure), or any other predictive maintenance-related information.

In some examples, the system(s) may receive or otherwise obtain input data representing a query (e.g., a natural language query) or other request for information. The query or request may be sent by a computing device that is executing an instance of a user interface associated with a predictive maintenance system. In some instances, the input data may be multimodal. For instance, the input data may include text data representing the query, audio data representing speech containing the query, image data or a stream of image data (e.g., a video) representing an image or video associated with the query, etc. For instance, in the context of image data or the stream of image data, a user may use sign language gestures to sign the query, and the images may depict the sign language gestures made by the user. Additionally, or alternatively, the query may include additional or supplemental data associated with the query, which may be represented using image data, audio data, video data, and/or any other type of data. As an example, a user may upload an image (e.g., an image of a chart, plot, etc.) and submit a query (e.g., by typing in the query, uttering the query, etc.) associated with the image, such as “based on these trends, what is the probability of this machine failing in the next year?” In such examples, the input data may include image data (corresponding to the additional data and/or the query), as well as text data, audio data, video data, 3D design or CAD data, universal scene descriptor (USD) data, and/or any other data.

In some examples, the system(s) may analyze the query represented in the input data and determine an optimal language model to use to generate a response to the query. For instance, the system(s) may select the most optimal language model to use to respond to the query based on the complexity of the query and/or inference costs associated with running the language model. As an example, for a lower complexity query the system(s) may select a lower cost language model that should still produce a sufficient output, and for a more complex query the system(s) may select a higher cost language model. In some examples, the system(s) may compute a score for the query that is indicative of the level of complexity of the query. The system(s) may then compare the score for the query to a number of complexity thresholds associated with the different language models available to select from. The complexity thresholds may be indicative of how powerful the language models are (e.g., how complex of queries the language models are able to handle). The language models may be ranked in order of lowest cost to highest cost, and the system(s) may select the lowest cost language model that is capable of providing a reliable output for the given complexity level of the query. Additionally, in some examples, the system(s) may select different types of language models based on the content of the input query. For instance, if the input data is multimodal as described herein, the system(s) may select a multi-modal language model instead of, or in addition to, a large language model.

As described herein, in some examples, the system(s) may use the selected language model(s) to execute an integrated reasoning and decision-making framework (e.g., ReACT framework) and generate the response to the query. In some examples, the reasoning and decision-making framework may include various phases, which may include, but are not limited to, a planning phase, an agent selection phase, an agent execution phase, and a response formation phase. Additionally, in some instances, the system(s) may repeat one or more phases of the framework using the language model(s) until a satisfactory response to the query is determined. As described herein, in some examples, the system(s) may use one or more configuration files associated with the agentic architecture to train, augment, or otherwise guide (e.g., few-shot engineering, prompt engineering, etc.) the output of the language model(s). The configuration file(s) may include information and/or specifications associated with the agentic architecture. For example, the configuration file(s) may indicate, among other things, the uses, capabilities, tools, etc. of each one of the agents, sample queries for each of the agents, network endpoints for the agents, and/or any other information. As an example, for a database agent, the configuration file may indicate that the database agent may be used to obtain certain types of information (e.g., machine logs, history, etc.) stored in a database, that a sample query (e.g., sub-query) for the agent may include something like “provide a list of all machines that failed due to component 4 on Jan. 4, 2015,” and a valid URL, IP address, etc. for the database agent. In some examples, the configuration file(s) may be applied as an input (e.g., training input, augmentation input, few-shot engineering input, etc.) to the language model(s) selected by the system(s). For instance, the configuration file(s) may be applied to the language model(s) to enable the language model(s) to determine relevant agents to invoke for responding to certain queries, to generate instructions or sub-queries in a format or schema that is understood by the agents and/or their tools, to reason through complex queries, etc.

In some examples, the system(s) may use the language model(s) to process the input data (e.g., the query) and determine a plan for responding to the query. For instance, during the planning phase of the framework, the system(s) may use the language model(s)—which may include one or more large language models (LLMs), one or more vision language models (VLMs), one or more multimodal language models (MMLMs), and/or any other models—to process the input data and determine the plan for responding to the query. In some examples, the planning phase may include decomposing the query into one or more subqueries. The sub query(s) may correspond to individual tasks to complete to generate a response to the query. For example, if the query were to state “plot seasonal patterns in machine failures due to component X,” the system(s) may use the language model(s) to decompose the query into the tasks of (1) obtaining historical machine failures due to component X, (2) identifying seasonal patterns in those failures, and (3) plotting the seasonal patterns in those failures.

Based on the plan, the system(s) may, in some examples, use the language model(s) to select a subset of the agents to invoke to perform various tasks or otherwise obtain information for responding to the query. That is, the system(s) may, using the language model(s), determine which tasks to assign to which agents, the order in which to assign those tasks, etc. For example, continuing the scenario from above in which the query is decomposed into the tasks of (1) obtaining historical machine failures due to component X, (2) identifying seasonal patterns in those failures, and (3) plotting the seasonal patterns in those failures, the system(s) may use the language model(s) to determine to assign the first task to a database agent, assign the second task to a predictive agent, and assign the third task to a visualization agent.

In some examples, during the agent execution phase the system(s) may cause the agents to execute one or more of the tasks for responding to the query. For instance, the system(s) may send the tasks (or data corresponding to the tasks) to the agents. In some examples, the system(s) may use the language model(s) to generate text data representing instructions (e.g., sub-queries) to send to the agents, and the agents may use one or more second language models to process the text data and understand the instructions/task it is to perform on behalf of the system(s). As one example, the system(s) may text data representing the first task of “obtain all data related to machine failures due to component X” to the database agent. The database agent may use the second language model(s) to process the text data and determine what it needs to do to respond. In some instances, the database agent may use the second language model(s) to convert the text data/task into an API call or SQL statement to obtain the necessary information (e.g., data for machine failures due to component X) from a relational database on behalf of the system(s).

During the response formation phase, in some examples, the system(s) may use the language model(s) to evaluate results obtained from the agents and plan further tasks or prepare a response to the query to return to the user. For instance, continuing the above example, once the data related to the machine failures due to component X is obtained from the database agent, the system(s) may further plan to send this data to the predictive agent in order to identify the seasonal patterns in those machine failures. For instance, the system(s) may send this data along with an instruction to identify the seasonal patterns in the machine failures. Similarly, once the system(s) identifies the seasonal patterns in the failures using the predictive agent, the system(s) may replan to invoke the visualization agent to plot the seasonal patterns.

In some examples, the system(s) may generate the response to the query using the information obtained from the different agents. For example, during the response formulation phase, the system(s) may use the language model(s) to evaluate all the information it knows or has obtained related to the query, and determine whether it is capable of providing a response to the query. For instance, continuing the above example, if the system(s) obtains the plot and determines the plot accurately represents the seasonal patterns in the machine failures due to component X, the system(s) may use the language model(s) to generate the final response to the query. In some instances, such as in the current example, the response to the query may include a multimodal response. For instance, the response may include text data reciting “here is a plot of the seasonal patterns in machine failures due to component X: [graph],” wherein “[graph]” may correspond to image data representing an image of the plot.

Additionally, in some examples, the agents may perform various operations/tasks in addition to, or in the alternative of, obtaining information for the system(s) to respond to a query. For instance, the system(s) may request the specialized agents to store something in a database, to delete items from the database, to reorganize items in the database, to reformat stored data, update documentation, or perform any other output-type operations. Additionally, in some examples, the system(s) may include, among other agents, control agents that may control various machines, equipment, systems, etc. As an example, the system(s) may invoke a control agent to control one or more operations of the machines (e.g., autonomous or semi-autonomous machines). This may include, in some instances, causing one or more autonomous machines or vehicles to begin operation, cease operation, navigate to a specific location, or perform any other operations. Additionally, or alternatively, the control agents may be used to lock or unlock doors of buildings (e.g. to restrict or permit access), turn lighting off or on, operate HVAC systems, operate security cameras (e.g., turn off or on, adjust field of view (e.g., zoom, camera pose, orientation, etc.)), operate sound systems, operate appliances, activate or deactivate alarms, operate manufacturing equipment, or any other operations. In some instances, these operations may be performed in conjunction with user queries and/or may be performed autonomously and the user interface updated retroactively to inform users of the operations.

For instance, assume that the system(s) predicts a machine failure is likely to occur (e.g., responsive or non-responsive to a query). In such a scenario, the system(s) may determine to shut down the machine or remove it from rotation for maintenance, and then send a notification for output by the user interface to notify of the actions taken in response. Additionally, in such an example, the system(s) may automatically cause a different machine (e.g., one that is not predicted to fail) to be started up or otherwise used to replace the machine taken out of rotation. In other words, the system(s) may be used to detect events and autonomously respond to the events by taking one or more actions (e.g., deploy machines, lock doors, shut down equipment, maintain machines, replace machines, record the event, etc.).

In some examples, one or more of the models described herein, such as the language model(s) used by the system(s) and/or the agents, as well as any other machine learning models described herein, may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, the model(s) may be included within the container itself. In other examples, the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the model(s) may be deployed as an inference microservice to accelerate deployment on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring).

Additionally, in some examples the model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

In some embodiments, the systems and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage. In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the generative AI-based agentic architecture. For instance, the kiosk may communicate with the agentic architecture to obtain answers to complex queries related to predictive maintenance associated with the kiosk and/or one or more devices, machines, etc. managed by or otherwise associated with the kiosk.

In one or more embodiments, the systems and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the systems may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. In some examples, the gaming application and/or the gaming console, PC, tablet, or the other gaming device may communicate with the generative AI-based agentic architecture. For instance, the gaming application and/or devices may communicate with the agentic architecture to obtain answers to complex queries related to predictive maintenance associated with the gaming application and/or devices, and/or one or more other devices, machines, etc. managed by or otherwise associated with the gaming application and/or the devices.

In some embodiments, the systems and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). In some examples, the video conferencing application and/or the video conferencing device may communicate with the generative AI-based agentic architecture. For instance, the video conferencing application and/or device may communicate with the agentic architecture to obtain answers to complex queries related to predictive maintenance associated with the video conferencing application and/or device, and/or one or more other devices, machines, etc. managed by or otherwise associated with the video conferencing application and/or device.

In some embodiments, the systems and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, AI-based agentic architecture for predictive maintenance described herein may enable the robotics application and/or system to answer complex queries related to predictive maintenance for the robotic systems. For instance, using the AI-based agentic architecture for predictive maintenance described herein, a robotic system may be able to determine optimal times to schedule maintenance, remaining useful life of certain robots and/or components, etc. Additionally, or alternatively, a robotics system may use the predictive maintenance systems described herein to manage maintenance for other systems or machines, and the robotics system may repair or service those other systems or machines based on information obtained from the predictive maintenance systems.

In some embodiments, the systems and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. In some examples, the IVI system or IX application may communicate with the AI-based agentic architectures described herein to answer complex queries related to predictive maintenance for the vehicle, the IVI system, and/or the IX application.

In some embodiments, one or more transformer engines (TEs) may be implemented. The transformer engine may use micro-tensor scaling to optimize performance and accuracy—such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for furing increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

Although examples may be described herein with respect to using machine learning models, such as neural networks, language models, or generative models, this is not intended to be limiting. For example, and without limitation, any of the various machine learning models, generative models, language models, and/or neural networks described herein may include or be replaced with any type of model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) netweorks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, video management, operations center oversight and control, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

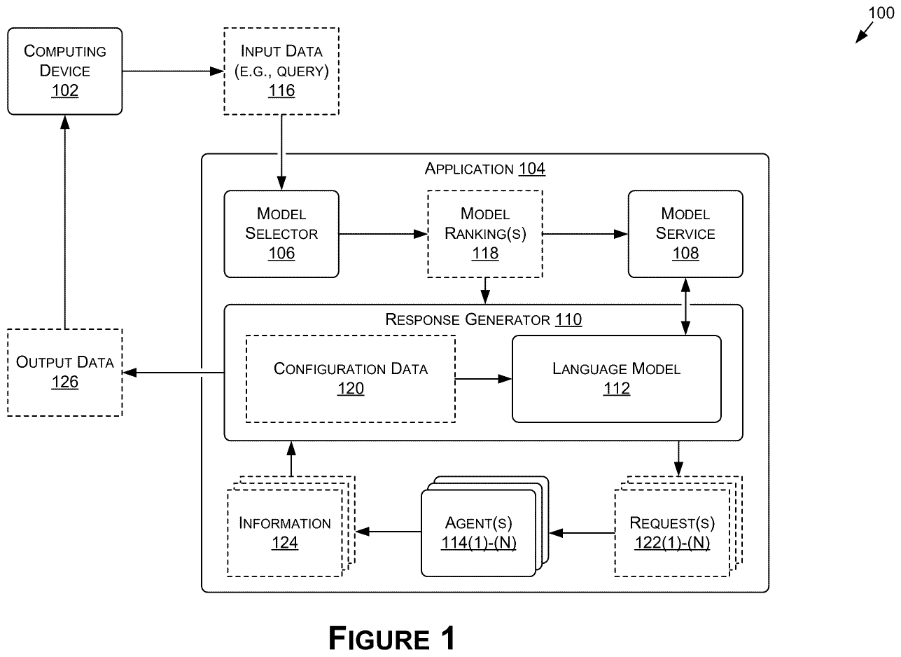

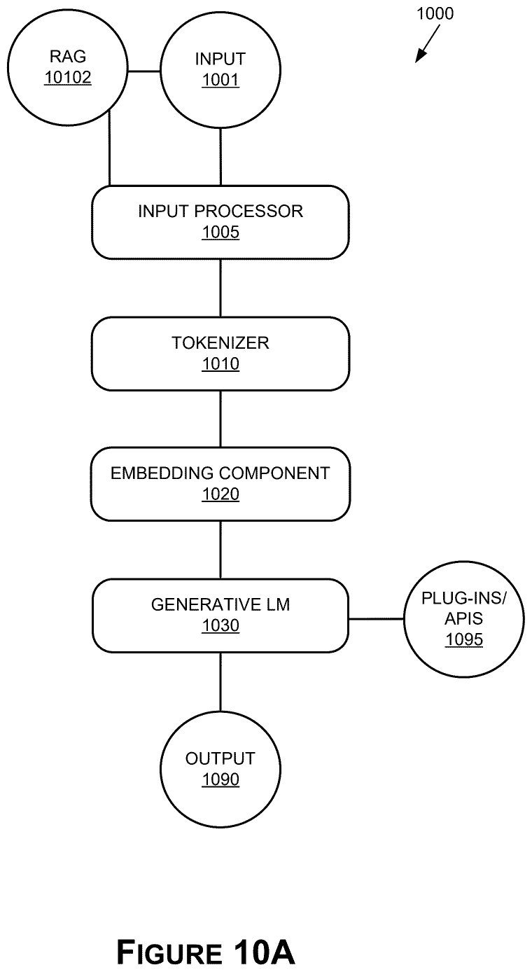

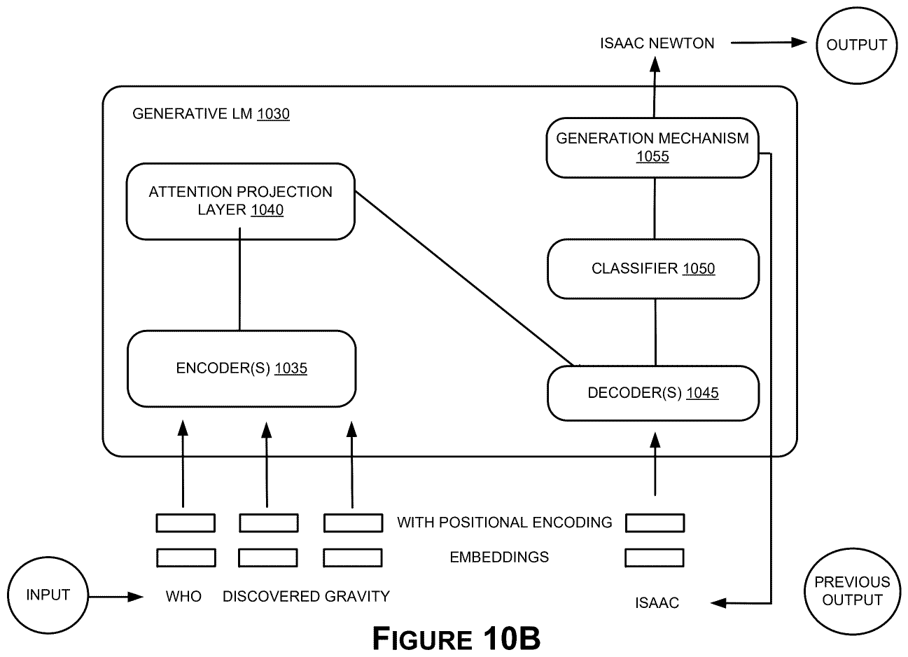

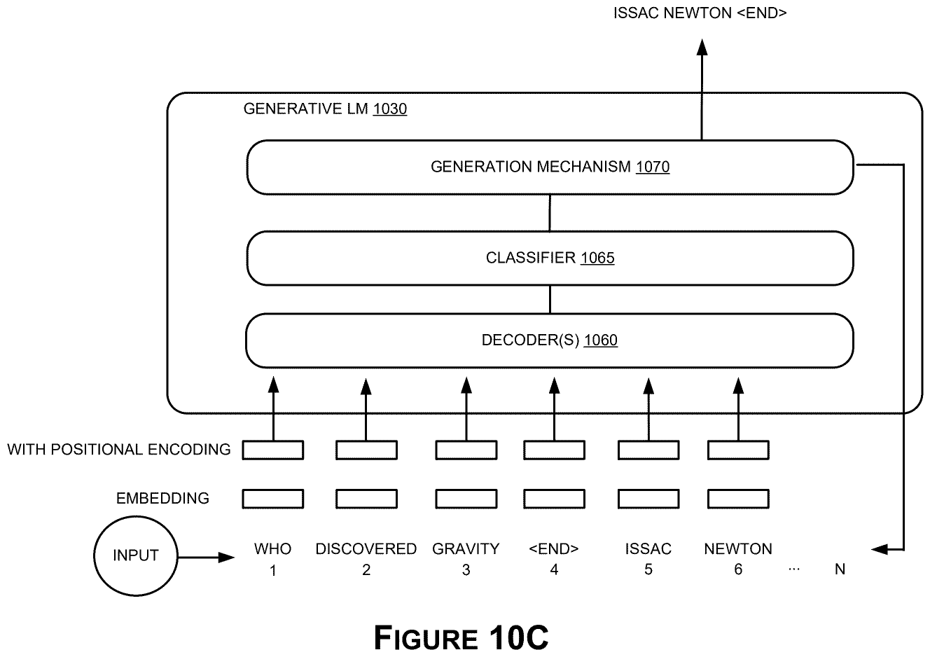

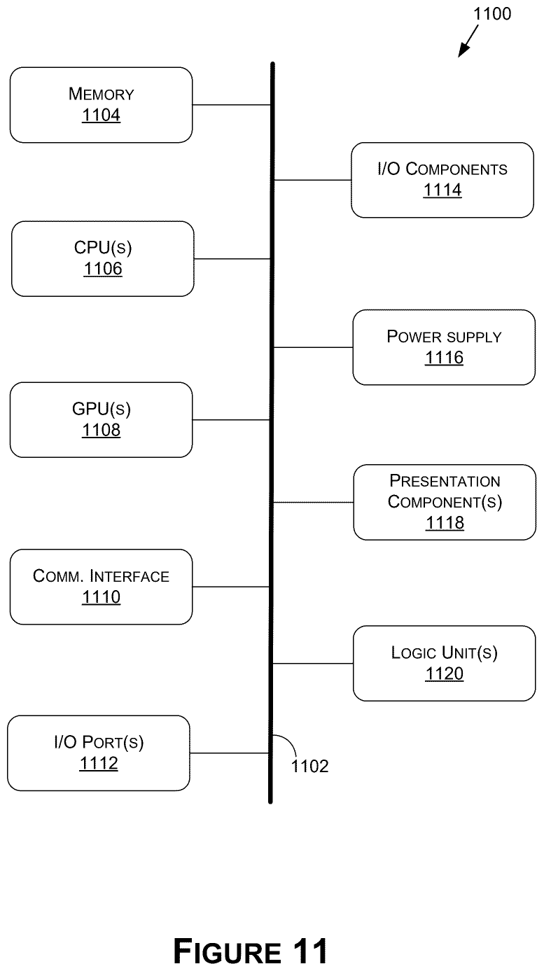

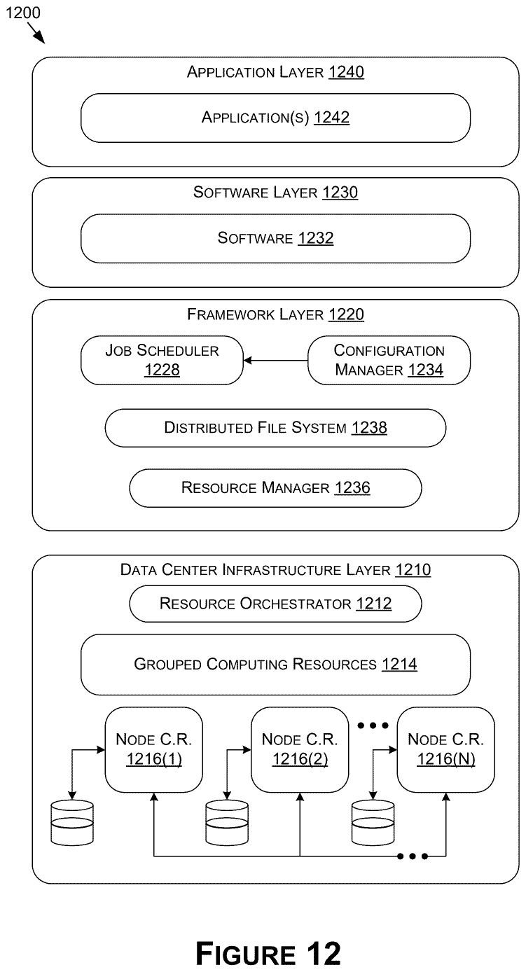

With reference to FIG. 1, FIG. 1 is a data flow diagram illustrating an example of a process 100 for using a generative AI-based agentic architecture for predictive maintenance to generate a response to a query, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 10A-10C), one or more computing devices or components thereof (e.g., as described in FIG. 11), and/or one or more data centers or components thereof (e.g., as described in FIG. 12).

The process 100 may be implemented using, amongst additional or alternative components, a computing device 102, an application 104, a model selector 106, a model service 108, a response generator 110, a language model 112, and one or more agents 114(1)-114(N) (where “N” may represent any number of the agent(s) 114). As a brief overview, the process 100 may include the application 104 receiving input data 116 from the computing device 102 and using the model selector 106 to compute one or more model rankings 118 indicative of optimal language models to use to respond to the query. In some examples, the model service 108 may use the model ranking(s) 118 to select a language model 112 for the response generator 110 to use to generate a response to the query. Additionally, or alternatively, the response generator 110 may use the model ranking(s) 118 to select/obtain the language model 112 from the model service 108. The response generator 110 may apply configuration data 120 to the language model 112, and based on the language model 112 processing the input data 116 and the configuration data 120, the response generator 110 may send one or more requests 122(1)-122(N) (where “N” may represent any number of the request(s) 122) to the agent(s) 114. The agent(s) 114 may process the request(s) 122 and return information 124 to the response generator 110. The response generator 110 may use the language model 112 to generate output data 126 based at least on the input data 116 and the information 124. The output data 126 may represent a response to the query contained in the input data 116, and the response generator 110 and/or the application 104 may send the output data 126 to the computing device 102.

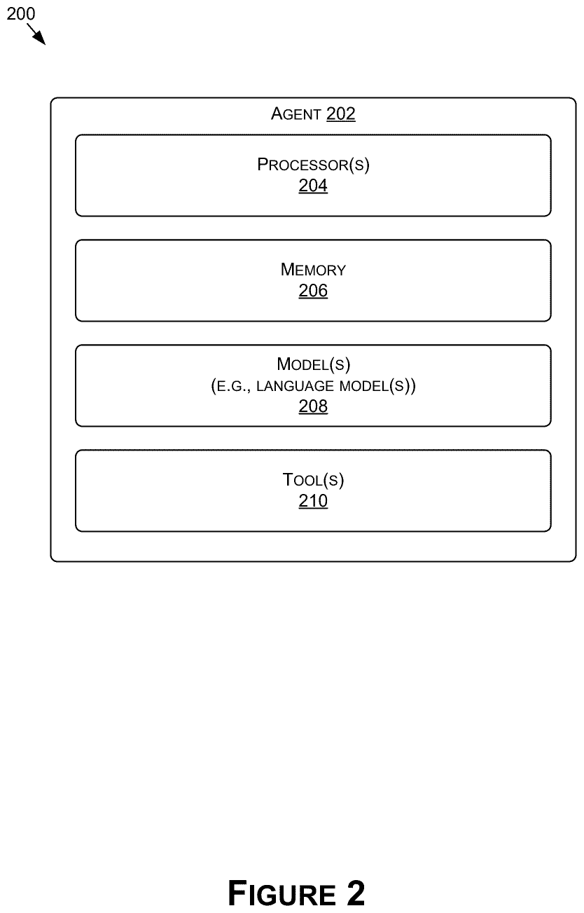

In some examples, the response generator 110 and/or the agent(s) 114 may include various models, tools, components, and/or other features that enable the agents to collaborate with one another and reason through complex tasks or queries. For instance, FIG. 2 is a block diagram illustrating example detail 200 associated with an agent 202, in accordance with some embodiments of the present disclosure. The agent 202 may correspond to one or more of the response generator 110 and/or the agent(s) 114 from the example of FIG. 1. As shown in the example of FIG. 2, the agent 202 may include one or more processors 204 that may correspond to any of the processors described herein, memory 206, one or more models 208, and one or more tools 210.

Although shown as separate from the memory 206, in some examples, the memory 206 may store one or more of the model(s) 208 and/or the tool(s) 210. In some instances, the memory 206 may serve as a repository for the internal records of the agent 202 and/or the agent's interactions with users and/or other agents. The memory may include short-term memory and/or long-term memory. In some examples, the short-term memory may act as a ledger of the actions and thoughts the agent 202 processes while addressing a specific query, essentially capturing the agent's “train of thought.” In contrast, the long-term memory may function as a logbook that documents ongoing interactions and events between the agent 202 and other agents and/or users, encompassing conversation histories that can extend over weeks or months.

As described herein, the model(s) 208 may include one or more language models (e.g., the language model 112) that may serve as the core engine for the agent's understanding, reasoning, and action taking. The model(s) 208 may process inputs by analyzing the context and intent behind queries, drawing on extensive training on diverse text data to produce coherent and contextually relevant responses. By leveraging advanced algorithms, such as those found in Transformer architectures, the model(s) 208 may capture nuanced meanings and relationships between words, allowing it to handle complex language tasks like conversation, summarization, and translation. Essentially, the model(s) 208 may enable the agent 202 to engage in meaningful interactions, adapt to different contexts, and provide informative answers, all while continuously learning from its interactions to enhance future performance.

While many of the examples described herein are with respect to using language models, and specifically, large language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) netweorks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

The tool(s) 210 may represent or include defined, executable workflows that enable the agent 202 to perform various tasks efficiently. These tool(s) 210 may include specialized third-party APIs designed to enhance the capabilities of the agent 202. For example, the tool(s) 210 of the agent 202 may include a Retrieval-Augmented Generation (RAG) pipeline to provide context-aware responses, or a code interpreter to tackle intricate programming challenges. Additionally, the agent 202 may use the tool(s) 210 to access external APIs to search for information online, retrieve real-time data from services such as weather APIs, interact with instant messaging platforms, interact with relational databases (e.g., SQL databases) or any other databases, interact with models (e.g., predictive models, etc.), generate visualization of data, etc. By leveraging its tool(s) 210, the agent 202 may expand its functionality, enabling the agent 202 to handle a wide range of inquiries and tasks with greater accuracy and relevance.

Referring back to the example of FIG. 1, in some examples the input data 116 may be sent by the computing device 102, which may be executing an instance of a user interface associated with a predictive maintenance system. In some instances, the input data 116 may be multimodal. For instance, the input data 116 may include text data representing the query, audio data representing speech containing the query, image data or a stream of image data (e.g., a video) representing an image or video associated with the query, etc. For instance, in the context of image data or the stream of image data, a user may use sign language gestures to sign the query, and the images may depict the sign language gestures made by the user. Additionally, or alternatively, the input data 116 include additional or supplemental data associated with the query, which may be represented using image data, audio data, video data, and/or any other type of data. As an example, a user may upload an image (e.g., an image of a chart, plot, etc.) and submit a query (e.g., by typing in the query, uttering the query, etc.) associated with the image, such as “based on these trends, what is the probability of this machine failing in the next year?” In such examples, the input data 116 may include image data (corresponding to the additional data and/or the query), as well as text data, audio data, or any other data.

In some examples, the process 100 may include the application 104 using the model selector 106 to analyze the input data 116 and/or the query and determine the optimal language model 112 to use to generate the response to the query. For instance, the model selector 106 may determine the model ranking(s) 118, which may be indicative of the most optimal language model to use to respond to the query based on the complexity of the query and/or inference costs associated with running the language models. As an example, for lower complexity queries the model ranking(s) 118 may indicate higher rankings for weaker and/or lower cost language models, while for more complex queries the model ranking(s) may indicate higher rankings for larger and/or higher cost language models. In other words, when a query is simple, a low-cost model can be used and still produce sufficient outputs, but when a query is more complex, a higher-cost model may be used to produce the best results. In some examples, the model selector 106 may compute a score for the query that is indicative of the level of complexity of the query. The model selector 106 may then compare the score for the query to a number of complexity thresholds associated with the different language models available to select from the model service 108. The complexity thresholds may be indicative of how powerful the language models are (e.g., how complex of queries the language models are able to handle), the size of the language models, what kind of queries the language models can respond to, etc. When ranking the models, the model selector 106 may filter the models based on whether their complexity thresholds can handle the complexity score associated with the query (e.g., discard from consideration the models that are not strong enough to provide a reliable answer), and then rank the models based on their inference cost and/or other metrics or parameters. In this way, the highest-ranking model of the model ranking(s) 118 may be the model that is sufficiently large enough to handle the complexity of the query while also minimizing the inference cost. Additionally, in some examples, the model selector 106 may select different types of language models based on the content of the input query. For instance, if the input data 116 is multimodal as described herein, the model selector 106 may select a multi-modal language model. In some examples, the highest-ranking model from the model ranking(s) 118 may be used by the response generator 110 to generate the response to the query.

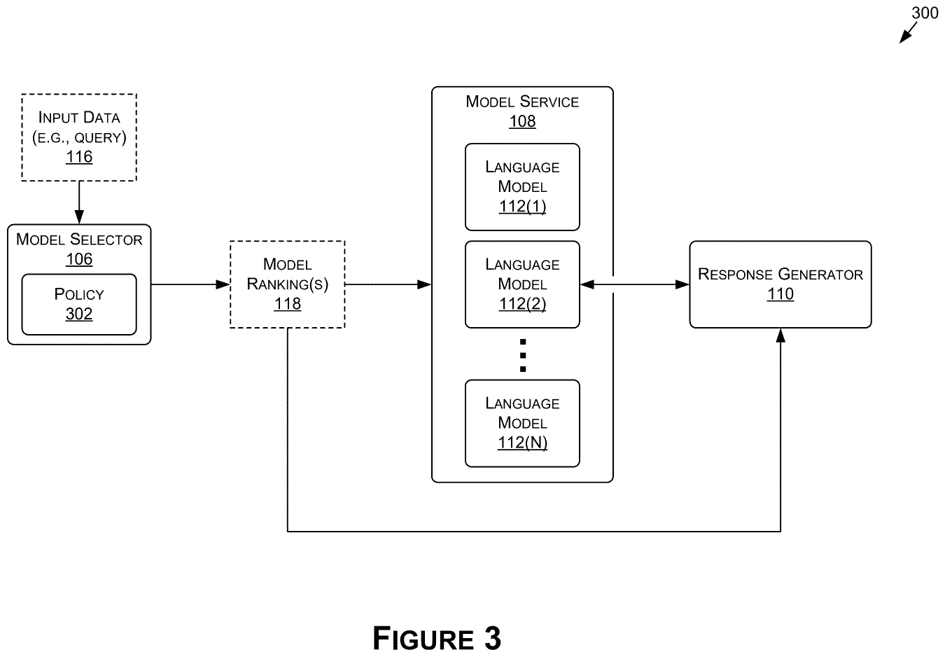

For instance, FIG. 3 is a data flow diagram illustrating an example of a process 300 for policy-based selection of a language model, in accordance with some embodiments of the present disclosure. As shown, the model selector 106 may obtain the input data 116 and use a policy 302 to generate the model ranking(s) 118. In some examples, the policy 302 may specify how the models (e.g., the language models 112(1)-112(N) of the model service 108) are to be ranked. The policy 302 may be user or enterprise configured and may vary depending on the implementation. For instance, in some cases the policy 302 may specify to prefer selecting larger or more expensive models, and in other cases the policy 302 may specify to prefer minimizing cost and selecting the weakest model possible that will still produce an acceptable result.

As described herein, the model selector 106 may, in some instances, rank the language models 112 of the model service 108 based on the complexity of the query included in the input data 116. In some examples, the model selector 106 may determine the complexity of the query using a language model or other machine learning model, using algorithmic or rule based techniques, or any other techniques. For instance, the model selector 106 may use a language model to decompose the query into multiple tasks, and the total number of the tasks may correspond to how complex the query is (e.g., 2 tasks may be an easy query, while 5 tasks may be a difficult query). Additionally, or alternatively, the model selector 106 may determine the complexity of the query based on a total number of words, sub-words, characters, etc. included in the input data 116. Additionally, or alternatively, the model selector 106 may use a machine learning model to determine the complexity of the query (e.g., a model that is trained to guess the complexity based on previous queries with known complexity scores).

Based on the query complexity score and the policy 302, the model selector 106 may compute the model ranking(s) 118. For instance, if the policy 302 specifies to always use the lowest inference cost language model 112, the model selector 106 may first determine which models are strong enough to handle the query based on its complexity score, and then rank those models in order of their inference cost (e.g., with the lowest-cost model receiving the highest ranking). The model ranking(s) 118 may then be used to select a specific language model, such as the second language model 112(2) to use to generate the response. For instance, the model ranking(s) 118 may be sent to the model service 108 and/or the response generator 110 and used by these endpoints to select the appropriate model, which in the example of FIG. 2 corresponds to the second language model 112(2). In some instances, this may include the response generator 110 and/or the model selector 106 forwarding the input data 116 to the second language model 112(2).

Referring back to the example of FIG. 1, in some examples, the application 104 and/or the response generator 110 may use the configuration data 120—which may represent one or more configuration files associated with the agentic architecture—to train, augment, or otherwise guide (e.g., few-shot engineering, prompt engineering, etc.) the outputs of the language model 112. The configuration data 120 may represent information and/or specifications associated with the multi-agent architecture. For example, the configuration data 120 may indicate, among other things, the uses, capabilities, tools, etc. of the agent(s) 114, sample queries (e.g., sample versions of the request(s) 122) for the agent(s) 114, network endpoints for the agent(s) 114, and/or any other information associated with the agent(s) 114. In some examples, the configuration data 120 may be applied as an augmentation and/or training input to the language model 112. For instance, the language model 112 may be augmented and/or trained, using the configuration data 120, to determine relevant ones of the agent(s) 114 to invoke for responding to certain queries included in the input data 116, to generate instructions or sub-queries in a format or schema that is understood by the agent(s) 114, to reason through complex queries, etc. By augmenting the language model 112 with the configuration data 120, the systems of the present disclosure may enhance the model's functionality by providing the language model 112 with additional information beyond the model's training.

In some instances, in addition to—or in the alternative of—training a specialized language model to perform the various functionalities described herein, the response generator 110 may perform prompt engineering and/or few-shot engineering to enable the language model 112 to generalize and perform specific tasks effectively. For instance, during inference the response generator 110 may apply the configuration data 120 to the language model 112, and the configuration data 120 may include one or more examples to enable the language model 112 to generalize and perform one or more similar tasks effectively. To implement this, the response generator 110 may select the example(s) that closely resembles the target task in structure and context. For instance, if the goal is to generate Python code, the response generator 110 might present 2-3 examples of functional, commented code portions demonstrating tasks like computing factorials, sorting arrays, handling file I/O, etc. The example(s) may be included in the prompt with clear instructions, ensuring the language model 112 understands the expected input-output relationship.

In various instances, the response generator 110 may use the example(s) as a template to guide the output of the language model 112. For example, the response generator 110 may add a directive like, “Following the format of the examples above, write a Python script that calculates the Fibonacci sequence up to a given number.” Additionally, the response generator 110 may validate the outputs for correctness and iterate on the example(s) if the language model 112 fails to meet expectations. By strategically framing the example(s) and prompts, the response generator 110 may use few-shot engineering to enable the language model 112 to produce contextually accurate and task-specific results without requiring extensive fine-tuning, or in addition to fine-tuning.

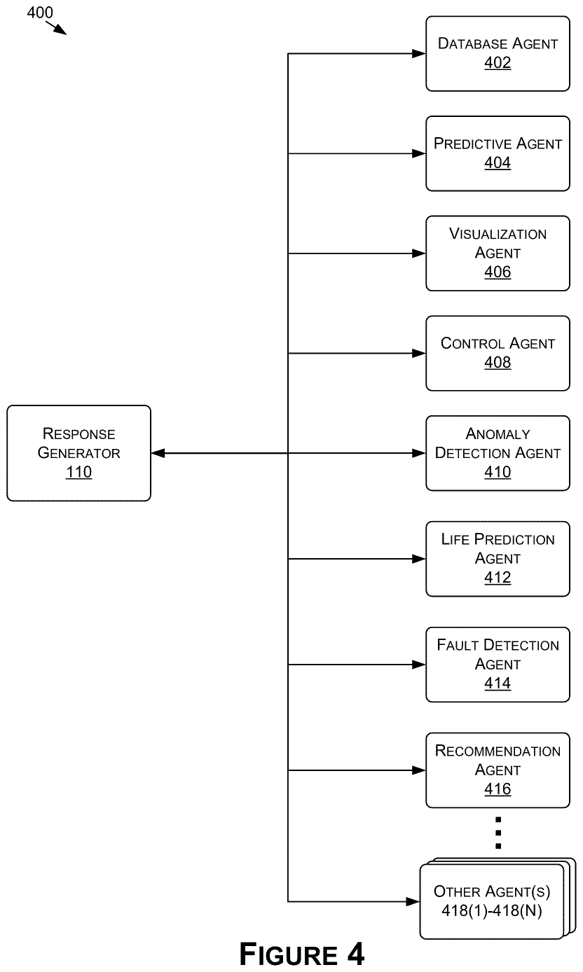

In some examples, the agent(s) 114 may include various types of agents configured to perform various types of operations and/or complete various types of tasks. For instance, FIG. 4 illustrates an example of a multi-agent architecture 400 associated with a predictive maintenance system, in accordance with some embodiments of the present disclosure. The multi-agent architecture 400 may include the response generator 110 and a plurality of specialized agents, such as a database agent 402, a predictive agent 404, a visualization agent 406, a control agent 408, an anomaly detection agent 410 (e.g., for detecting anomalies in a machine or system), a life prediction agent 412 (e.g., for predicting the remaining useful life of a machine or system), a fault detection agent 414 (e.g., for detecting faults associated with a machine or system), a recommendation agent 416 (e.g., for recommending actions), and one or more other agents 418(1)-418(N) (where “N” may represent any number of the other agents 418). Although shown as including a single agent of each type, in some examples, the multi-agent architecture 400 may include one or more agents of one or more types, such as one or more of the database agent 402, the predictive agent 404, the visualization agent 406, the control agent 408, the anomaly detection agent 410, the life prediction agent 412, the fault detection agent 414, the recommendation agent 416, etc.

In some examples, the agents illustrated in FIG. 4 may be similar to the agent 202 of the example of FIG. 2. As such, the agents may include the model(s) 208 and/or the tool(s) 210, and the agents may use the model(s) 208 to reason and/or take actions. For instance, the database agent 402 may receive a query from the response generator 110 saying to “fetch all the historical data for failures of machine Y” and use a second language model (e.g., the model(s) 208) to understand the request and convert the request into an API call, SQL statement, etc. to obtain the requested information from the database(s). In other words, the database agent 402 may retrieve information from, for instance, a SQL database by using the second language model to translate ordinary questions written in natural language into read-only SQL commands, run the SQL commands against a SQL database, and return the results.

In some instances, the anomaly detection agent 410 may identify irregular patterns in sensor data associate with a system or machine that may indicate deviations from normal operating conditions (e.g., early indicators of potential issues that could lead to failure if not addressed). In some examples, the anomaly detection agent 410 may continuously monitor real-time sensor data from various machine or system components—such as pressure, temperature, vibrations, etc.—to detect anomalies that may differ from the established baseline associated with the machine or system. In some instances, once an anomaly is detected, the anomaly detection agent 410 may generate an alert(s) that highlights the affected component(s) and the type of anomaly(ies) detected (e.g., temperature spike, unexpected vibration, etc.).

In some examples, the life prediction agent 412 may be configured to, among other things, predict the remaining useful life of a machine or system (e.g., a turbofan engine) in real-time. For instance, using one or more machine learning models to process failure history data, maintenance history data, machine usage data (e.g. conditions of operation, data collected from sensors, etc.), machine feature data (e.g., engine size, make, model, location, etc.), machine operator data (e.g., name of operator(s), experience of operator(s), etc.), the life prediction agent 412 may predict the remaining useful life of a machine or system.

In some instances, the fault detection agent 414 may be configured to identify failing components of a machine or system and assess the overall health state of the machine or system to minimize costs and avoid unexpected downtime. For example, the fault detection agent 414 may predict which specific machine or system components are likely to fail. In the case of a turbofan system, this may include predicting whether the fan, compressors, and/or turbines are likely to fail. In some examples, the fault detection agent 414 may use a binary vector output to indicate which components are at risk of failure (e.g., [0, 1, 0, 1, 0] may indicate potential failure in the “Low-Pressure Compressor” and “High-Pressure Turbine”). Additionally, or alternatively, the fault detection agent 414 may predicts whether a machine or system is currently in a healthy state, providing warnings for necessary maintenance.

The recommendation agent 416 may provide action recommendations to mitigate risks, extend remaining useful life, and/or prevent component failures. For instance, once anomalies are detected and/or faults are predicted, the recommendation agent 416 may leverage maintenance history records to provide targeted action recommendations to mitigate risks, extend remaining useful life, prevent failures, etc. As one example, in the case of turbofans for airplanes and/or other aircraft, the recommendation agent 416 may, among other things, provide recommendations for flight planning adjustments—such as optimizing altitude and/or air speed—to ensure the most efficient conditions for reducing component wear and maximizing operational efficiency, recommend specific maintenance windows based on predicted remaining useful life, provide recommendations for dispatching and optimizing the allocation of aircraft based on different flight conditions and operational goals, or provide any other recommendations. Additionally, in some instances, the recommendation agent 416 may provide an estimate impact on remaining useful life and engine health. For example, a recommendation may indicate that reducing the throttle by 10% may increase the remaining useful life by 5 cycles, etc.

In some examples, the control agent 408 may control various machines and/or systems to carry out any of the recommendations of the recommendation agent 416. For instance, the control agent 408 may cause operations to be performed based on the recommendations from the recommendation agent 416. Consider, for example, a fleet of autonomous machines that are managed or supervised, at least in part, using the system(s) of the present disclosure. In such an example, if the recommendation agent 416 recommends that reducing speed of the machines by 10% may extend the useful life of the machines by 20%, then the control agent 408 may cause the machines to reduce their overall speed by 10%, or change other operating parameters. While this is just one example, in other examples, the control agent 408 may cause a machine or system to perform any other kinds of operations.

Referring back to the example of FIG. 1, in some examples, the response generator 110 may use the selected language model 112 to execute an integrated reasoning and decision-making framework (e.g., ReACT framework) and generate the response to the query. In some examples, the reasoning and decision-making framework may include various phases, which may include, but are not limited to, a planning phase, an agent selection phase, an agent execution phase, and a response formation phase. Additionally, in some instances, the response generator 110 may repeat one or more phases of the framework using the language model 112 until a satisfactory response to the query is determined. During this framework, the response generator 110 may send the request(s) 122 to the agent(s) 114 and receive the information 124 in return, and then use the information 124 to generate the output data 126 to return to the computing device 102.

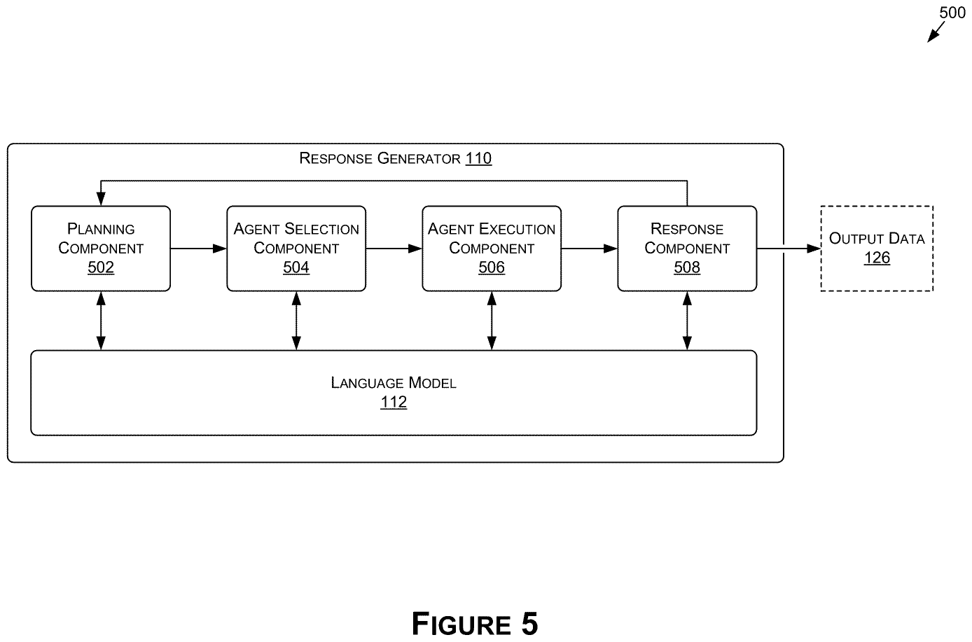

For instance, FIG. 5 illustrates an example workflow 500 associated with a reasoning and decision-making framework that may be executed, at least in part, using a language model, in accordance with some embodiments of the present disclosure. In some examples, a planning component 502 of the response generator 110 may use the language model 112 to process the input data 116 (e.g., the query) and determine a plan for responding to the query. For instance, during the planning phase of the framework, the planning component 502 of the response generator 110 may use the language model 112—which may include one or more large language models (LLMs), one or more vision language models (VLMs), one or more multimodal language models (MMLMs), and/or any other models—to process the input data 116 and determine the plan for responding to the query. In some examples, the planning phase may include using the language model 112 to decompose the query into one or more subqueries. The sub query(s) may correspond to individual tasks to complete to generate a response to the original query. For example, if the query were to state “plot seasonal patterns in machine failures due to component X,” the planning component 502 of the response generator 110 may use the language model 112 to decompose the query into the tasks of (1) obtaining historical machine failures due to component X, (2) identifying seasonal patterns in those failures, and (3) plotting the seasonal patterns in those failures.

Based on the plan, an agent selection component 504 of the response generator 110 may, in some examples, use the language model 112 to select a subset of the agents 114 to invoke to perform various tasks or otherwise obtain information for responding to the query. That is, the agent selection component 504 of the response generator 110 may, using the language model 112, determine which tasks to assign to which particular agents 114, the order in which to assign those tasks to the agents 114, etc. For example, continuing the scenario from above in which the query is decomposed into the tasks of (1) obtaining historical machine failures due to component X, (2) identifying seasonal patterns in those failures, and (3) plotting the seasonal patterns in those failures, the agent selection component 504 of the response generator 110 may use the language model 112 to determine to assign the first task to the database agent 402, assign the second task to the predictive agent 404, and assign the third task to the visualization agent 406.

In some examples, an agent execution component 506 of the response generator 110 may cause the agents 114 to execute one or more of the tasks for responding to the query. For instance, the agent execution component 506 of the response generator 110 may send the tasks (e.g., the request(s) 122) to the agents 114. In some examples, the agent execution component 506 of the response generator 110 may use the language model 112 to generate text data representing the tasks to send to the agents 114. The agents may then receive the tasks (or data representing the tasks), perform the tasks, and return any necessary information to the response generator 110.

A response component 508 of the response generator 110 may use the language model 112 to evaluate the results/information obtained from the agents 114 and either plan further tasks (e.g., returning to the planning component 502) or prepare a response to the query to return to the user (e.g., output data 126). For instance, continuing the above example, once the data related to the machine failures due to component X is obtained from the database agent, the response component 508 of the response generator 110 may further plan to send this data to the predictive agent in order to identify the seasonal patterns in those machine failures. For instance, the response generator 110 may send this data to the predictive agent along with an instruction to identify the seasonal patterns in the machine failures. Similarly, once the response component 508 of the response generator 110 receives the seasonal patterns in the failures from the predictive agent, the response component 508 of the response generator 110 may replan to invoke the visualization agent to plot the seasonal patterns.

Once the response component 508 of the response generator 110 determines all relevant information has been obtained, the response component 508 may generate the output data 126 representing the response to the query. For example, during the response formulation phase, the response component 508 of the response generator 110 may use the language model 112 to evaluate all the information it knows or has obtained from the agents related to the query, and determine whether it is capable of providing a response to the query. For instance, continuing the above example, if the response component 508 of the response generator 110 obtains the plot and determines the plot accurately represents the seasonal patterns in the machine failures due to component X, the response generator 110 may use the language model 112 to generate the final response to the query.

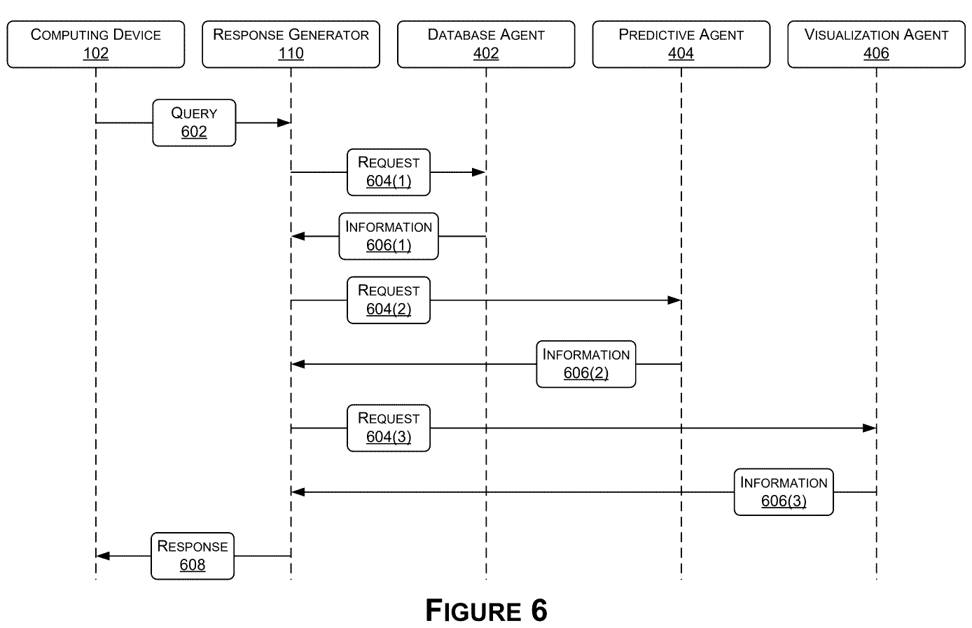

Referring now to FIG. 6, FIG. 6 is a data flow diagram illustrating example data communications that may take place during execution of the reasoning and decision-making framework of FIG. 5, in accordance with some embodiments of the present disclosure. For instance, the response generator 110 may receive a query 602 from the computing device 102. The response generator 110 may use the planning component 502 to plan how to respond to the query and the agent selection component 504 to determine to send a first request 604(1) to the database agent 402. The database agent 402 may respond to the first request 604(1) with first information 606(1).

Based on receiving the first information 606(1), the response generator 110 may use the response component 508 to determine that more information is necessary to respond to the query 602. As such, the response generator 110 may again use the planning component 502 to plan the next steps for responding to the query 602 based on the first information 606(1) and use the agent selection component 504 to determine to send a second request 604(2) to the predictive agent 404. The predictive agent 404 may respond to the second request 604(2) with second information 606(2).

Based on receiving the second information 606(2), the response generator 110 may use the response component 508 to determine that more information is necessary to respond to the query 602. As such, the response generator 110 may again use the planning component 502 to plan the next steps for responding to the query 602 based on the first information 606(1) and the second information 606(2), and use the agent selection component 504 to determine to send a third request 604(3) to the visualization agent 404. The visualization agent 406 may respond to the third request 604(3) with third information 606(3).

Based on receiving the third information 606(3), the response generator 110 may use the response component 508 to determine whether more information is necessary to respond to the query 602. For instance, the response generator 110 may use the language model to process all the information available related to the query (e.g., the query 602 itself, the information 606, etc.)—which may be obtained from memory—and determine that it has all the necessary information to generate a response 608 to the query. As such, the response generator 110 may generate the response 608 to the query 602 using the language model and the information available to it. The response 608 may then be send to the computing device 102.

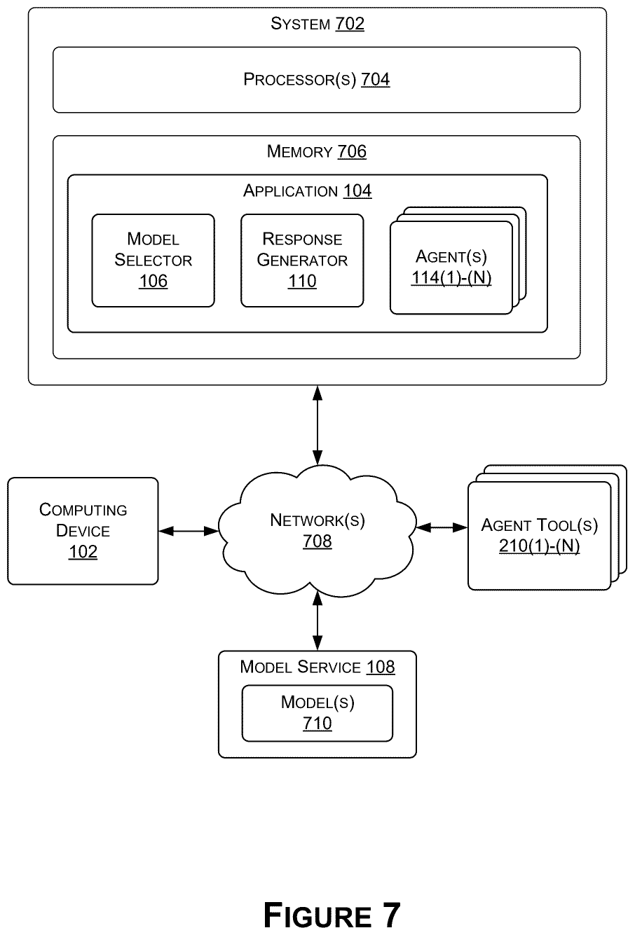

Referring now to FIG. 7, FIG. 7 is a block diagram illustrating an example of a system 702 that may perform one or more of the processes described herein, in accordance with some embodiments of the present disclosure. As shown, the system 702 (which may represent, and/or include, the example computing device(s) 1100 and/or the example data center 1200) may include one or more processors 704 (which may be similar to, and/or include, the CPUs 1106 and/or the GPUs 1108) and memory 706 (which may be similar to, and/or include, the memory 1104). For instance, the memory 706 may store one or more of the application 104, the model selector 106, the response generator 110, and/or the agent(s) 114. Additionally, the processor(s) 704 may execute one or more of the application 104, the model selector 106, the response generator 110, and/or the agent(s) 114 to perform one or more of the processes described herein.

In some examples, the system 702 may communicate with the computing device 102, the agent tool(s) 210, and the model service 108 over one or more network(s) 708. For instance, the system 702 may receive input data representing a natural language query from the computing device 102, and use the processor(s) 704 to execute the application 104 (and/or the components therein) and determine a response to the query. In some instances, the application 104 may select one or more models 710 from the model service 108 to use to execute a reasoning and decision-making framework to respond to the query. Additionally, in some examples, the application 104 may forward the query (e.g., the query plus instructions or prompts to use the reasoning and decision-making framework) to the selected model(s) 710 over the network(s) 708, or obtain the model(s) 710 from the model service 108 for use locally on the system 702. In some examples, the agent(s) 114 may communicate with their tool(s) 210 over the network(s) 708. For instance, the tool(s) 210 may include an external database, service, application, or other system that the agent(s) 114 is configured to interact with or use. Once the application 104 has determined a response to the query, the application 104 may return the response to the computing device 102.

Additionally, in some examples, the agent(s) 114 may perform requested operations/tasks in addition to, or in the alternative of, obtaining information for the response generator 110 to respond to a query. For instance, the response generator 110 may request the agent(s) 114 to store something in a database, to delete items from the database, to reorganize items in the database, to reformat stored data, update documentation, or perform any other output-type operations. Additionally, in some examples, the agent(s) 114 may include control agents that may control various machines, equipment, resources, building or resource access, etc. As an example, based on receiving a query from a user, the response generator 110 may invoke a control agent to control one or more operations of one or more machines (e.g., autonomous or semi-autonomous machines). This may include, in some instances, causing one or more autonomous machines or vehicles to use a different path, begin operating, cease operating, navigate to a specific location, or any other operations. Additionally, or alternatively, the control agents may be used to lock or unlock doors of buildings (e.g. to restrict or permit access), turn lighting off or on, operate HVAC systems, operate security cameras (e.g., turn off or on, adjust field of view (e.g., zoom, camera pose, orientation, etc.)), operate sound systems, operate appliances, activate or deactivate alarms, operate manufacturing equipment, or any other operations.

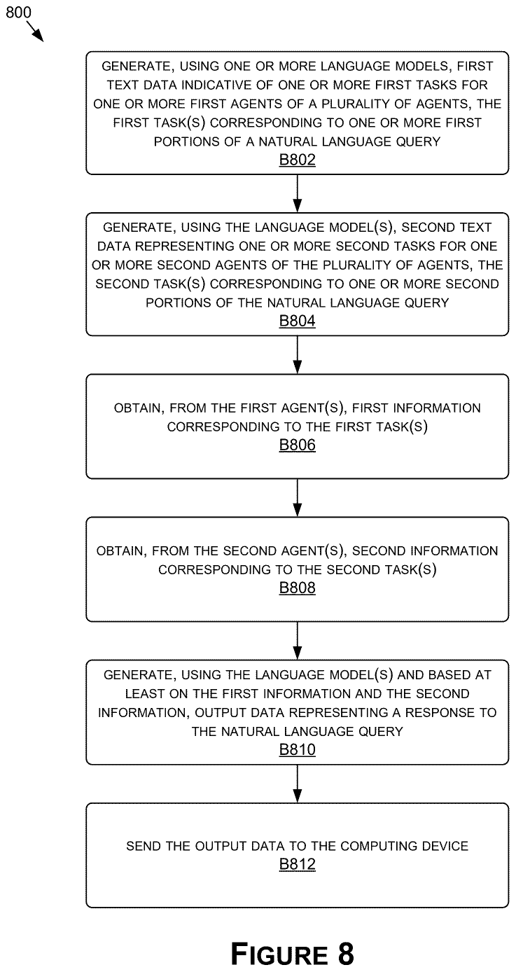

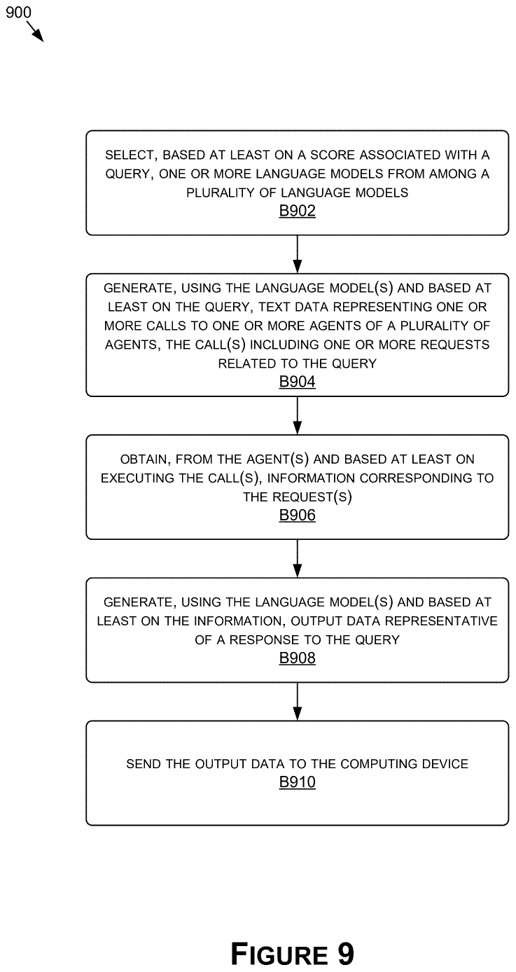

Now referring to FIGS. 8 and 9, each block of methods 800 and 900, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 800 and 900 are described, by way of example, with respect to the system of FIG. 1. However, these methods may additionally or alternatively be executed by any one system, or any combination of systems, including, but not limited to, those described herein.

FIG. 8 is a flow diagram illustrating an example of a method 800 that may be implemented by a generative AI-based agentic architecture for predictive maintenance, in accordance with some embodiments of the present disclosure. The method 800, at block B802, includes generating, using one or more language models, first text data indicative of one or more first tasks for one or more first agents of a plurality of agents, the first task(s) corresponding to one or more first portions of a natural language query. For instance, the response generator 110 may use the language model 112 to generate the first text data indicative of the first task(s) (e.g., first request 122(1)) for a first agent 114(1). In some examples, the response generator 110 may use the language model 112 to decompose the original query represented in the input data 116, and the first portion of the natural language query may correspond to a first sub-query decomposed from the original query.

The method 800, at block B804, includes generating, using the language model(s), second text data representing one or more second tasks for one or more second agents of the plurality of agents, the second task(s) corresponding to one or more second portions of the natural language query. For instance, the response generator 110 may use the language model 112 to generate the second text data indicative of the second task(s) (e.g., second request 122(2)) for a second agent 114(2). In some examples, the response generator 110 may use the language model 112 to decompose the original query represented in the input data 116, and the second portion of the natural language query may correspond to a second sub-query decomposed from the original query.

The method 800, at block B806, includes obtaining, from the first agent(s), first information corresponding to the first task(s). For instance, the response generator 110 may obtain first information 124 from the first agent 114(1) responsive to the first request 122(1). In some examples, the information may include information obtained from a database, such as historical data associated with a machine.

The method 800, at block B808, includes obtaining, from the second agent(s), second information corresponding to the second task(s). For instance, the response generator 110 may obtain second information 124 from the second agent 114(2) responsive to the second request 122(2). In some examples, the information may include predictive information (e.g., a prediction related to the machine) or visual information (e.g., a plot or chart related to the health or state of the machine).

The method 800, at block B810, includes generating, using the language model(s) and based at least on the first information and the second information, output data representing a response to the natural language query. For instance, the response generator 110 may use the language model 112 to process the first information and the second information to generate the output data 126 representing the response. In some examples, the response may indicate one or more states, predictions, or other information associated with one or more machines monitored using a predictive maintenance system. In some examples, the predictive maintenance system may monitor the machine(s) to, among other things, predict failures of the machines before the failures actually occur. The predictive maintenance system may use one or more of the techniques of this disclosure to monitor the machines and allow user to easily interact with the predictive maintenance system.

The method 800, at block B812, includes sending the output data to the computing device. For instance, the application 104 and/or the response generator 110 may send the output data 126 to the computing device 102. In some examples, the output data 126 may represent a multi-modal output (e.g., textual information plus something else, such as audio, video, image, etc.).

FIG. 9 is a flow diagram illustrating an example of a method 900 for responding to a query using an agentic architecture for predictive maintenance, in accordance with some embodiments of the present disclosure. The method 900, at block B902, includes selecting, based at least on a score associated with a query, one or more language models from among a plurality of language models. For instance, the response generator 110 may use the model ranking(s) 118 to select the language model 112 from among a plurality of language models offered by the model service 108. In some examples, the score may be based on a level of complexity of the query, and the one or more language models may be selected based on their ability to handle or respond to queries having that level of complexity, while also minimizing inference costs. In other words, stronger (e.g., larger, better, etc.) language models may be offered by the model service 108, but using the one or more selected language models may produce a satisfactory response at the lowest inference cost.

The method 900, at block B904, includes generating, using the language model(s) and based at least on the query, text data representing one or more calls to one or more agents of a plurality of agents, the call(s) including one or more requests related to the query. For instance, the response generator 110 may use the language model 112 to generate the text data representing the call(s) to the agent(s) 114. In some examples, the call(s) may include the request(s) 122 related to the query. For instance, the response generator 110 may use the language model 112 to decompose the query into a number of tasks to be completed in order to generate the response, and the request(s) 122 included in the call(s) may correspond to these task(s), as described herein.

The method 900, at block B906, includes obtaining, from the agent(s) and based at least on executing the call(s), information corresponding to the request(s). For instance, the response generator 110 may obtain the information 124 corresponding to the request(s) 122 based at least on executing the call(s). In some examples, the information obtained from the agent(s) may include information related to one or more machines monitored using a predictive maintenance system. Such information may include, but is not limited to, historical information related to failures of the machines, historical information related to failures of certain components of the machines, plots related to the failures of the machines or components, predictions related to the historical information, predictions of future failures of the machines or components, etc.

The method 900, at block B908, includes generating, using the language model(s) and based at least on the information, output data representative of a response to the query. For instance, the response generator 110 may use the language model 112 to process the information 124 and generate the output data 126 representing the response. In some examples, the response may indicate one or more states, predictions, or other information associated with the machines monitored by the predictive maintenance system. For instance, the query may ask when a certain machine is expected to fail, and the response may indicate a window of time when the machine is expected to fail.

The method 900, at block B910, includes sending the output data to the computing device. For instance, the application 104 and/or the response generator 110 may send the output data 126 to the computing device 102. In some examples, the output data 126 may represent a multi-modal output (e.g., textual information plus something else, such as audio, video, image, etc.) as described herein.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) - such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type - including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model - or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices:
memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: generating, using one or more language models and based at least on input data representing a natural language query related to one or more states associated with one or more systems, at least: first text data indicative of one or more first tasks for one or more first agents of a plurality of agents, the one or more first tasks corresponding to one or more first portions of the natural language query; and second text data indicative of one or more second tasks for one or more second agents of the plurality of agents, the one or more second tasks corresponding to one or more second portions of the natural language query; obtaining, from the one or more first agents, first information corresponding to the one or more first tasks; obtaining, from the one or more second agents, second information corresponding to the one or more second tasks; generating, using the one or more language models and based at least on the first information and the second information, output data indicative of the one or more states associated with the one or more systems; and sending the output data to the computing device.

B. The method of paragraph A, further comprising: determining a score indicative of a level of complexity associated with the natural language query; and selecting the one or more language models from among a plurality of language models based at least on a determination that a magnitude of the score is less than one or more thresholds corresponding to the one or more language models.

C. The method of any one of paragraphs A-B, further comprising: determining that one or more first costs corresponding to the one or more language models are less than one or more second costs corresponding to one or more second language models; and selecting the one or more language models based at least on the one or more first costs being less than the one or more second costs.

D. The method of any one of paragraphs A-C, wherein at least one of the one or more first agents or the one or more second agents include at least a database agent that is to: generate, using one or more second language models and based at least on the one or more requests, one or more Structure Query Language (SQL) statements; cause execution of the one or more SQL statements by one or more relational databases; and output one or more results received from the one or more relational databases responsive to the execution of the one or more SQL statements, wherein at least one of the first information or the second information includes the one or more results.

E. The method of any one of paragraphs A-D, wherein at least one of the one or more first agents or the one or more second agents include at least a predictive agent that is to: determine, using one or more machine learning models and based at least on historical data corresponding to one or more systems, one or more predictions associated with at least one of: one or more previous states of the one or more systems, one or more current states of the one or more systems, or one or more future states of the one or more systems, wherein at least one of the first information or the second information includes the one or more predictions.

F. The method of any one of paragraphs A-E, wherein at least one of the one or more first agents or the one or more second agents include at least a visualization agent that is to generate one or more visual representations of historical information corresponding to the one or more systems, wherein at least one of the first information or the second information includes the one or more visual representations.

G. The method of any one of paragraphs A-F, wherein the generating of the second text data using the one or more language models is further based at least on the first information obtained from the one or more first agents.

H. A system comprising: one or more processors to: select, based at least on a score associated with a query, one or more language models from among a plurality of language models; generate, using the one or more language models and based at least on the query, text data representing one or more calls to one or more agents of a plurality of agents, the one or more calls including one or more requests related to the query; obtain, from the one or more agents and based at least on executing the one or more calls, information corresponding to the one or more requests; generate, using the one or more language models and based at least on the information, output data representative of a response to the query; and send the output data to a computing device.

I. The system of paragraph H, the one or more processors further to: compute the score associated with the query based at least on a level of complexity associated with the query; and determine that the score is less than one or more thresholds corresponding to the one or more language models, wherein the selection of the one or more language models is further based at least on the score being less than the one or more thresholds.

J. The system of any one of paragraphs H-I, the one or more processors further to: determine that one or more first costs corresponding to the one or more language models are less than one or more second costs corresponding to one or more second language models of the plurality of language models, wherein the selection of the one or more language models is further based at least on the one or more first costs being less than the one or more second costs.

K. The system of any one of paragraphs H-J, wherein the one or more agents include at least a database agent that is to: generate, using one or more second language models and based at least on the one or more requests, one or more Structure Query Language (SQL) statements; cause execution of the one or more SQL statements by one or more relational databases; and output one or more results received from the one or more relational databases responsive to the execution of the one or more SQL statements, wherein the information includes the one or more results.

L. The system of any one of paragraphs H-K, wherein the one or more agents include at least a predictive agent that is to: determine, using one or more machine learning models and based at least on historical data corresponding to one or more systems, one or more predictions associated with at least one of: one or more previous states of the one or more systems, one or more current states of the one or more systems, or one or more future states of the one or more systems, wherein the information includes the one or more predictions.

M. The system of any one of paragraphs H-L, wherein the one or more agents include at least a visualization agent that is to generate one or more visual representations of historical information corresponding to the one or more systems, wherein the information includes the one or more visual representations.

N. The system of any one of paragraphs H-M, the one or more processors further to: generate, using the one or more language models and based at least on the query and the information, second text data representing one or more second calls to one or more second agents of the plurality of agents; and obtain, from the one or more second agents and based at least on executing the one or more second calls, second information associated with responding to the query, wherein the generation of the output data is further based at least on the second information.

O. The system of any one of paragraphs H-N, wherein the plurality of agents include at least: one or more database agents; one or more predictive agents; and one or more visualization agents.

P. The system of any one of paragraphs H-O, wherein the one or more agents include at least one of a control agent that is to cause one or more machines to perform one or more operations responsive to the one or more requests, wherein the information is indicative of the one or more operations performed by the one or more machines.

Q. The system of any one of paragraphs H-P, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

R. One or more processors comprising: processing circuitry to generate, using one or more language models to process information obtained based at least on calling one or more agents of a plurality of agents of an agentic architecture to perform one or more operations, output data representing a response to a natural language query received as input from a computing device, the output data indicative of one or more predicted states associated with one or more machines; and send the output data to the computing device.

S. The one or more processors of paragraph R, the processing circuitry further to select the one or more language models from among a plurality of language models based at least on content included in the natural language query and on cost information corresponding to the plurality of language models.

T. The one or more processors of any one of paragraphs R-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
generating, using one or more language models and based at least on input data representing a natural language query related to one or more states associated with one or more systems, at least:
first text data indicative of one or more first tasks for one or more first agents of a plurality of agents, the one or more first tasks corresponding to one or more first portions of the natural language query; and
second text data indicative of one or more second tasks for one or more second agents of the plurality of agents, the one or more second tasks corresponding to one or more second portions of the natural language query;
obtaining, from the one or more first agents, first information corresponding to the one or more first tasks;
obtaining, from the one or more second agents, second information corresponding to the one or more second tasks;
generating, using the one or more language models and based at least on the first information and the second information, output data indicative of the one or more states associated with the one or more systems; and
sending the output data to the computing device.

2. The method of claim 1, further comprising:
determining a score indicative of a level of complexity associated with the natural language query; and
selecting the one or more language models from among a plurality of language models based at least on a determination that a magnitude of the score is less than one or more thresholds corresponding to the one or more language models.

3. The method of claim 1, further comprising:
determining that one or more first costs corresponding to the one or more language models are less than one or more second costs corresponding to one or more second language models; and
selecting the one or more language models based at least on the one or more first costs being less than the one or more second costs.

4. The method of claim 1, wherein at least one of the one or more first agents or the one or more second agents include at least a database agent that is to:
generate, using one or more second language models and based at least on the one or more requests, one or more Structure Query Language (SQL) statements;
cause execution of the one or more SQL statements by one or more relational databases; and
output one or more results received from the one or more relational databases responsive to the execution of the one or more SQL statements,
wherein at least one of the first information or the second information includes the one or more results.

5. The method of claim 1, wherein at least one of the one or more first agents or the one or more second agents include at least a predictive agent that is to:
determine, using one or more machine learning models and based at least on historical data corresponding to one or more systems, one or more predictions associated with at least one of:
one or more previous states of the one or more systems,
one or more current states of the one or more systems, or
one or more future states of the one or more systems,
wherein at least one of the first information or the second information includes the one or more predictions.

6. The method of claim 1, wherein at least one of the one or more first agents or the one or more second agents include at least a visualization agent that is to generate one or more visual representations of historical information corresponding to the one or more systems, wherein at least one of the first information or the second information includes the one or more visual representations.

7. The method of claim 1, wherein the generating of the second text data using the one or more language models is further based at least on the first information obtained from the one or more first agents.

8. A system comprising:
one or more processors to:
select, based at least on a score associated with a query, one or more language models from among a plurality of language models;
generate, using the one or more language models and based at least on the query, text data representing one or more calls to one or more agents of a plurality of agents, the one or more calls including one or more requests related to the query;
obtain, from the one or more agents and based at least on executing the one or more calls, information corresponding to the one or more requests;
generate, using the one or more language models and based at least on the information, output data representative of a response to the query; and
send the output data to a computing device.

9. The system of claim 8, the one or more processors further to:
compute the score associated with the query based at least on a level of complexity associated with the query; and
determine that the score is less than one or more thresholds corresponding to the one or more language models,
wherein the selection of the one or more language models is further based at least on the score being less than the one or more thresholds.

10. The system of claim 8, the one or more processors further to:
determine that one or more first costs corresponding to the one or more language models are less than one or more second costs corresponding to one or more second language models of the plurality of language models,
wherein the selection of the one or more language models is further based at least on the one or more first costs being less than the one or more second costs.

11. The system of claim 8, wherein the one or more agents include at least a database agent that is to:
generate, using one or more second language models and based at least on the one or more requests, one or more Structure Query Language (SQL) statements;
cause execution of the one or more SQL statements by one or more relational databases; and
output one or more results received from the one or more relational databases responsive to the execution of the one or more SQL statements,
wherein the information includes the one or more results.

12. The system of claim 8, wherein the one or more agents include at least a predictive agent that is to:
determine, using one or more machine learning models and based at least on historical data corresponding to one or more systems, one or more predictions associated with at least one of:
one or more previous states of the one or more systems,
one or more current states of the one or more systems, or
one or more future states of the one or more systems,
wherein the information includes the one or more predictions.

13. The system of claim 8, wherein the one or more agents include at least a visualization agent that is to generate one or more visual representations of historical information corresponding to one or more systems, wherein the information includes the one or more visual representations.

14. The system of claim 8, the one or more processors further to:
generate, using the one or more language models and based at least on the query and the information, second text data representing one or more second calls to one or more second agents of the plurality of agents; and
obtain, from the one or more second agents and based at least on executing the one or more second calls, second information associated with responding to the query,
wherein the generation of the output data is further based at least on the second information.

15. The system of claim 8, wherein the plurality of agents include at least:
one or more database agents;
one or more predictive agents; and
one or more visualization agents.

16. The system of claim 8, wherein the one or more agents include at least one of a control agent that is to cause one or more machines to perform one or more operations responsive to the one or more requests, wherein the information is indicative of the one or more operations performed by the one or more machines.

17. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. One or more processors comprising:
processing circuitry to:
generate, using one or more language models to process information obtained based at least on calling one or more agents of a plurality of agents of an agentic architecture to perform one or more operations, output data representing a response to a natural language query received as input from a computing device, the output data indicative of one or more predicted states associated with one or more machines; and
send the output data to the computing device.

19. The one or more processors of claim 18, the processing circuitry further to select the one or more language models from among a plurality of language models based at least on content included in the natural language query and on cost information corresponding to the plurality of language models.

20. The one or more processors of claim 18, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
